(19) United States
(12) Patent Application Publication
(10) Pub. No.: US 2009/0031298 A1
(43) Pub. Date: Jan. 29, 2009

(54) System and method for automated installation and/or launch of software

(76) Inventors: Jeffrey Brunet, Richmond Hill (CA); Yousuf Chowdhary, Maple (CA); Ian Collins, Markham (CA); Alex Lemelov, Thornhill (CA)

Correspondence Address: Gard and Kaslow, LLP, One 1st Street, Suite 9, Los Altos, CA, 94022, US

(21) Appl. No.: 12/157,671

(22) Filed: Jun. 11, 2008

Related U.S. Application Data
(60) Provisional application No. 60/933,972, filed on Jun. 11, 2007.

(51) Int. Cl. G06F 9/445

(52) U.S. Cl. 717/175

(57) ABSTRACT

Automated installation and launch of software on a computing system is accomplished by stored program code that determines the computing system configuration, selects a version of the software accordingly, uninstalls any software already installed on the computing system that conflicts with the software to be installed and launched, terminates any process running on the computing system that conflicts with the software to be installed and launched, and suppresses displays on the computing system while installing and launching the software on the computing system.

### CROSS-REFERENCE TO RELATED APPLICATIONS

This application claims the benefit of U.S. Provisional Patent Application No. 60/933,972 filed on Jun. 11, 2007 and entitled “Method and a System for an intelligent launcher for software applications,” which is incorporated herein by reference in its entirety.

### BACKGROUND OF THE INVENTION

1. Field of the Invention

The present invention relates generally to the field of installation and/or launching of software on computing systems and more particularly to the actions required of a user or operator during such installation and/or launching operation.

2. Description of the Prior Art

The computing systems of today have become increasingly more powerful and complicated. Relatively simple machines of the past were typically dedicated to one or two primary tasks yet today they are expected to handle numerous functions. With this increase in power and functionality has come a concomitant increase in system and software complexity. This complexity makes it increasingly difficult for users to perform such operations as installing and launching new software.

Referring now to FIG. 1, an exemplary computing system 100 can be seen. The computing system in this example is a desktop personal computer with a keyboard and display monitor as shown. Also shown is an optical disk 120, which for example may be a Compact Disk—Read Only Memory (“CD-ROM”) or a Digital Video Disk (“DVD”), containing software to be installed on the computing system 100. When a user wishes to install the software on the computing system, the user inserts the optical disk 120 into a drive 110 of computing system 100. The software on the optical disk 120 in the drive 110 is then installed on the computing system. However, there are numerous steps in this process that both confuse and annoy users and which can prevent the proper installation, launch or running of the software from occurring.

Referring now to FIG. 2, an Autoplay dialog box 200 can be seen which may be triggered by placing the optical disk 120 into the drive 110 of computing system 100 (FIG. 1). Autoplay dialog box 200 provides essentially no valuable information to a typical user and may not perform any necessary functionality in a particular situation yet still typically consumes time and implicitly asks the user to cancel the operation via the cancel button 210.

Referring now to FIG. 3, a Storage dialog box 300 can be seen. The Storage dialog box 300 is typically displayed by computing system 100 following display of the Autoplay dialog box 200 of FIG. 2. In the case of the Storage dialog box 300, the user is asked to inform the computing system 100 (and in particular the operating system of the computing system) as to what action the user wishes the computing system 100 to undertake. The user, however, may simply want some software to be installed and/or launched on the computing system and may be quite confused about the various choices presented in Storage dialog box 300.

Additional dialog boxes and message windows are also typically displayed when installing software on a computing system. These dialog boxes and message windows seek to inquire about other aspects of the computing system 100 which may affect the installation and/or operation of the software to be installed and/or launched on the computing system. For example, what operating system is running, what hardware components are installed, how the computing system is configured, etc., are all things oftentimes asked of the user. Yet many users are simply unable to answer such questions.

Additionally, there may be other software already installed or processes already running on the computing system 100 that can conflict with the installation and/or operation of the software to be installed. Addressing such conflicts typically requires the user to recognize the conflict and remove or uninstall the conflicting installed software or take action to terminate a conflicting running process.

All of this requires the user to understand enough about their computing system and software being installed and/or launched to make the right choices and provide the correct instructions. In reality, many users lack such knowledge and oftentimes fail to take the correct actions.

A further concern when installing and/or launching software on a computing system is that after all the above has occurred the user is then asked if they want to restart their computing system. Referring now to FIG. 4, an example restart dialog box 400 can be seen. The user, who oftentimes does not understand whether a restart of computing system 100 is necessary or important, is thus forced to make a decision about doing so. All this does is further frustrate and annoy the user.

What is needed is a simplified way to install and/or launch software on a computing system which avoids conflicts with already installed software and currently running processes and does not require the user to have to respond to a series of display messages and inquiries about the computing system configuration.

### SUMMARY

An exemplary computer readable medium containing program code for automatically installing software on a computing system comprising the steps of: initiating an AutoRun sequence of the computing system; investigating the computing system to identify any previously installed software known to conflict with the software to be installed on the computing system; uninstalling any identified previously installed software known to conflict with the software to be installed on the computing system; investigating the computing system to identify any currently running software known to conflict with the software to be installed on the computing system; terminating any identified currently running software known to conflict with the software to be installed on the personal computer; investigating the computing system to identify configuration details of the computing system; selecting a version of the software to be installed on the computing system based on the identified configuration details of the computing system; initiating installation of the selected version of the software to be installed on the computing system; identifying any displays on the computing system previously determined to not require user action; suppressing any identified displays on the computing system previously determined to not require user action; and completing installation of the selected version of the software to be installed on the computing system.

The exemplary computer readable medium containing program code for automatically installing software on a computing system of claim 1 where the program code can further comprise the steps of: initiating launch of the installed selected version of the software on the computing system; identifying any displays on the computing system previously determined to not require user action; eliminating any identified displays on the computing system previously determined to not require user action; and, completing launch of the installed selected version of the software on the computing system.

A further exemplary computer readable medium containing program code for automatically launching software on a computing system without requiring user action comprising the steps of: initiating an Autorun sequence of the computing system; investigating the computing system to identify any currently running software known to conflict with the software to be launched on the computing system; terminating any identified currently running software known to conflict with the software to be launched on the computing system; investigating the computing system to identify configuration details of the computing system; selecting a version of the software to be launched on the computing system based on the identified configuration details of the computing system; initiating launch of the selected version of the software to be launched on the computing system; identifying any displays on the computing system previously determined to not require user action; eliminating any identified displays on the computing system previously determined to not require user action; and, completing launch of the selected version of the software to be launched on the computing system.

A still further exemplary computer readable medium containing program code for automatically launching software on a computing system without requiring user action comprising the steps of: initiating an Autorun sequence of the computing system; investigating the computing system to identify any currently running software known to conflict with the software to be launched on the computing system; terminating any identified currently running software known to conflict with the software to be launched on the computing system; initiating launch of the software to be launched on the computing system; identifying any displays on the computing system previously determined to not require user action; eliminating any identified displays on the computing system previously determined to not require user action; and, completing launch of the software to be launched on the computing system.

### BRIEF DESCRIPTION OF DRAWINGS

FIG. 1 is a schematic representation of a computing system and an optical disk.

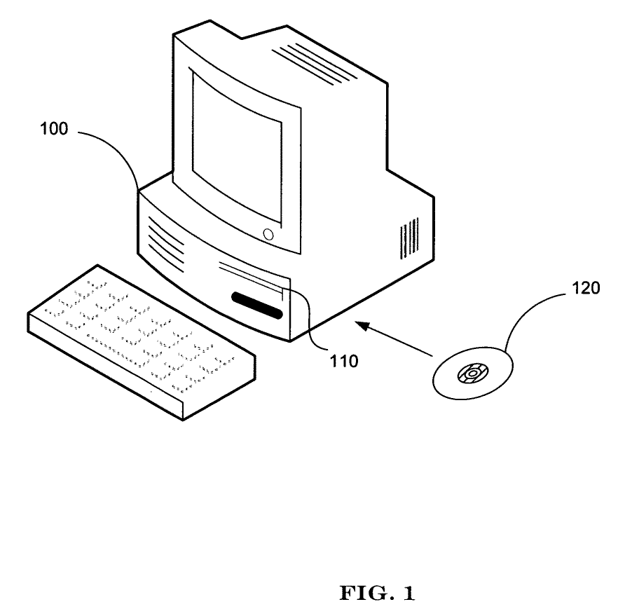

FIG. 2 is screen shot or capture of an Autoplay dialog box type display.

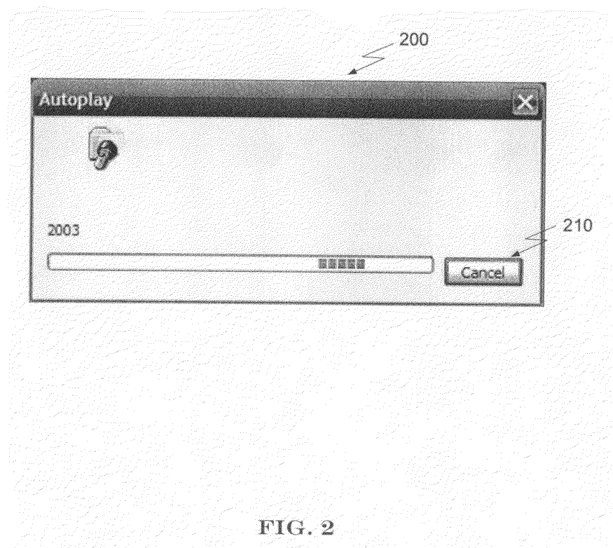

FIG. 3 is a screen shot or capture of a Storage dialog box type display.

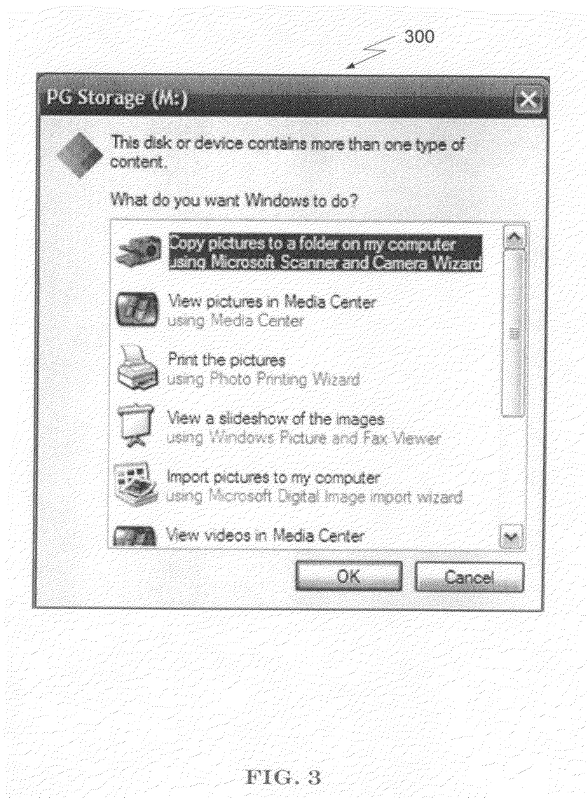

FIG. 4 is a screen shot or capture of a restart dialog box type display.

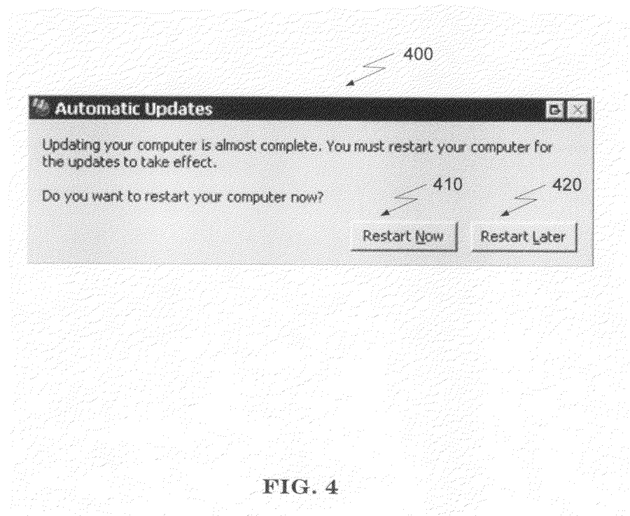

FIG. 5 is a flow chart representation of an exemplary method for automatic software installation and launching process according to one embodiment.

FIG. 6 is a flow chart representation of an exemplary method for investigating the computing system and selecting software accordingly.

FIG. 7 is a flow chart representation of another exemplary method for investigating the computing system and selecting software accordingly.

FIG. 8 is a flow chart representation of an exemplary method for suppressing displays on the computing system.

### DETAILED DESCRIPTION OF THE INVENTION

A system and method is provided for the automated installation and/or launch of software on a computing system. The system and method addresses conflicting software already installed on the computing system, terminates conflicting processes already running on the computing system, selects the correct version of the software for installation and/or launch based on investigating the computing system and then installs and/or launches the selected software on the computer system while suppressing the various displays requesting user action. In this way, the software can be installed and/or launched on the computing system in an automated fashion without bothering the user. Further, when combined with an AutoRun capability, the system and method provides a completely automated installation and/or launch process.

In one embodiment, the system and method comprise software computing instructions contained on a computer readable medium such as a CD-ROM or DVD. As such, the computer readable medium may contain both the software for performing the present method as well the software to be installed and/or launched on the computing system. Alternatively, the computer readable medium may simply contain the software for performing the present method and the software to be installed and/or launched on the computing system may be obtained elsewhere (e.g., another CD-ROM or DVD, downloaded across a network from another computing system, etc.) or already stored in memory of the computing system. In this way computer readable medium containing the software for performing the present method may be considered an “install/launch disk” and the computer readable medium containing the software to be installed and/or launched may be considered a “source disk.” Similarly, the computer readable medium itself is not limited to being an optical disk such as a CD-ROM or DVD, and can also be other forms of optical disks including a hybrid disk, a Compact Disc-Recordable (CD-R) or Compact Disc ReWritable (CD-RW) disk, a Digital Video Disc-Recordable (DVD-R and DVD+R) or Digital Video Disc ReWritable (DVD-RW and DVD+RW) disk, and can also be a flash based memory device (e.g., a Universal Serial Bus (USB) key), a Secure Digital (SD) card, a Compact Flash (CF) card, a hard disk drive, or any other computer readable medium.

It is to be understood that the computing system as described herein is not limited to being a personal computer and, instead, could be a server, a laptop, a set-top box, a cellular telephone, a Smartphone, a Personal Digital Assistant (PDA), a Personal Video Recorder (PVR), etc., running any of a variety of operating systems such as Microsoft Windows, MacOS, Linux, Unix, PalmOS, etc.

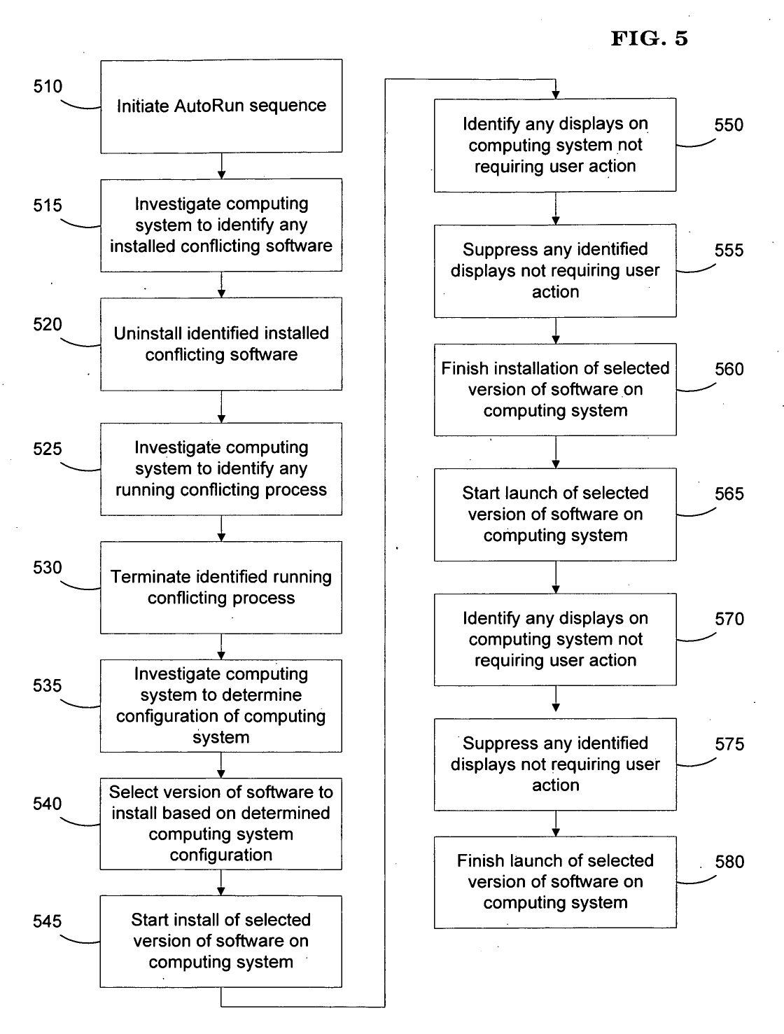

Referring now to FIG. 5, a flow chart representation of a process 500 according to an exemplary embodiment can be seen. After a user has placed an optical disk into, or other computer readable medium is connected to, a computing system, as described elsewhere herein, process 500 begins by 510 initiating an AutoRun sequence. When a computing system is running the Microsoft Windows XP operating system an AutoRun sequence can be initiated, as is known in the art, by having an autorun.inf file stored on the optical disk. The autorun.inf file initiates an AutoRun sequence which leads to the subsequent steps in the process.

In step 515, the computing system is investigated to identify any software already installed on the computing system which may be in conflict with the software to be installed and/or launched. This is accomplished by issuing commands to the operating system of the computing system to identify installed applications. For example, commands are known in the art for querying the Windows operating system to find out what applications are installed. The results are then compared to a list of applications known to be in conflict with the software to be installed and/or launched. An example of such a conflict is when the software to be installed and/or launched is a multimedia program and it is known that some other multimedia program, or an earlier version of the same multimedia program, would create problems in the operation, installation or functionality of the multimedia program to be installed and/or launched.

In step 520, any identified installed application known to be in conflict with the software to be installed and/or launched is uninstalled from the computing system. Uninstalling an application can be performed using any known technique including using such built in functions as the Microsoft Windows “Add or remove programs” feature.

In step 525, the computing system is investigated to identify any running process which may be in conflict with the software to be installed and/or launched. This is accomplished by issuing commands to the operating system of the computing system to identify any running process. For example, commands are known in the art for querying the Windows operating system to identify running processes (e.g., the “EnumProcesses” function). The results are then compared to a list of processes known to be in conflict with the software to be installed and/or launched. The multimedia program example above is an example of such a known conflicting process. Further, it is to be understood that although a process is generally understood to be a software program currently running or executing on the computing system, the term process as used herein should not be viewed so narrowly and can also encompass other executing functionalities including those of the operating system.

In step 530, any identified running process known to be in conflict with the software to be installed and/or launched is terminated so that it is no longer running on the computing system. Terminating an identified running process can be performed using any known technique including using such built in functions as the Microsoft Windows “TerminateProcess” function.

In step 535, the computing system is investigated to determine the configuration of the computing system. This is accomplished by issuing commands to the operating system of the computing system. For example, commands are known in the art for querying the Microsoft Windows operating system such as the “GetSystemInfo” function, the “GetVersionEx” function, the “GetSystemMetrics” function, and others known in the art. As is explained further elsewhere herein, the computing system configuration can include any of a large variety of hardware and or software details about the computing system (e.g., operating system type and version, Windows service pack status, processor type, processor speed, memory type, memory speed, input/output components, input/output capabilities, installed graphics capabilities, user preferences, system preferences, network capabilities and settings, peripheral devices and accessories, etc.).

Then, in step 540 a version of the software to be installed is selected based on the determined configuration of the computing system. It is to be understood that the selection of a version of the software to be installed and/or launched on the computing system is not limited to a version containing the entirety of the software. The version of software selected can also refer to independent or separate modules, drivers, components, subroutines, or any other form of separable program code which collectively make up the software to be installed and/or launched. As such, selection of a version of software to be installed and/or launched can be at any modular level of the software desired according to the determined computing system configuration. Further, selection of a version of the software to be installed and/or launched can be selection of one of several .exe files that is appropriate for the determined configuration of the computing system.

Starting the installation of the selected software on the computing system occurs in step 545. This is accomplished by issuing commands to the operating system of the computing system as is known in the art.

In step 550, displays on the computing system that do not require user action are identified. This is accomplished by issuing commands to the operating system of the computing system. For example, commands are known in the art for querying the Windows operating system to identify any displays (e.g., “EnumWindows” and “EnumDesktopWindows” functions). The results are then compared to a list of displays known to not require user action. Some examples of such displays include those having the following in their title:
“Autoplay”
“System Settings Change”
“Microsoft Windows”
“Windows Media Player—Device Setup”
“Windows Help”
“StarterOfficeGuardian.exe”

Then, in step 555 these displays are suppressed by either preventing them from being displayed or by directing the operating system to take the appropriate action rather than requiring the user to perform some action such as clicking on a button within the display or making a selection from a menu or list. For example, the Microsoft Windows “WM_Close” command function can be used to simply close a message window. It is to be understood that the displays to be suppressed include a wide range of possible display communications to the user of the computing system ranging from dialog boxes to message balloons to system alerts to system tray messages to pop-up windows, etc. As such, one approach to suppressing message balloons in the Microsoft Windows operating system environment is to simply disable them by setting “EnableBalloonTip” to a value of zero.

In step 560 installation of the software on the computing system then finishes.

Starting the launch of the selected software on the computing system occurs in step 565. This is accomplished by issuing commands to the operating system of the computing system as is known in the art. For example, the Microsoft Windows “ShellExecute” command function can be used to launch an application.

In step 570, displays on the computing system that do not require user action are identified. This is accomplished in basically the same fashion as step 550. Then, in step 575 these displays are suppressed. This is accomplished in basically the same fashion as step 555.

In step 580 launching the software on the computing system is then finished.

In one embodiment directed to software to be installed that requires restarting or rebooting the operating system of the computing system, this additional step may be performed after finishing installing the software. This is accomplished by issuing commands to the operating system of the computing system. For example, commands are known in the art for instructing the Microsoft Windows operating system to restart or reboot such as the “InitiateSystemShutdown” function. In a further embodiment, a dialog box is generated to tell the user to disconnect any hardware, such as a backup appliance in the form of a hard disk drive, before the restart operation occurs and to reconnect such hardware after the user enters any requested user name and password.

The installation and/or launching of software can thus be performed without requiring user action and without the annoyance of unnecessary displays inquiring about computing system configuration, what installation steps to perform, whether to restart/reboot, etc. Further, beginning the process with an AutoRun sequence provides a fully automated software installation and/or launch process requiring no more user interaction than placing an optical disk into a drive of a computing system.

It is to be understood that although the exemplary embodiment above is described in the context of a personal computer running the Windows operating system, the process is essentially the same for any suitable computing system running any of a large variety of operating systems. Such other operating systems may support an AutoRun functionality as triggered by an autorun.inf file or similar approach or, alternatively, via some other mechanism. One such alternative mechanism equally applicable is the self-designation by a peripheral device as being an AutoRun device as is supported by the Vista variant of the Windows operating system which allows any device to designate itself as an AutoRun device. Another alternative mechanism for initiating an AutoRun functionality is described in commonly-owned co-pending U.S. patent application Ser. No. 11/506,386 entitled “Data Backup Devices and Methods for Backing Up Data” filed on Oct. 10, 2006 and hereby incorporated by reference in its entirety.

It is also to be understood that the sequence of steps in FIG. 5 may occur in alternative orders and some of the steps may not be implemented at all in alternative embodiments. For example, steps 525 and 530 dealing with installed conflicting software may occur before steps 515 and 520 dealing with already running conflicting processes. Likewise, steps 535 and 540 dealing with selecting a version of the software based on the computing system configuration may occur before any of steps 515-530.

Similarly, it is to be understood that the steps described herein may be performed serially or in parallel as desired and appropriate. For example, in one embodiment steps 550 and 555 do not conclude before step 560 and, instead, continue through and until step 580 thus eliminating steps 570 and 575 as they would then be redundant. Further, in another embodiment steps 550 and 555, or steps 570 and 575 as the case may be, may continue to be performed for some period of time after the conclusion of step 560 and/or step 580 to address any displays which may otherwise occur shortly after step 560 and/or step 580 conclude.

Inasmuch as this is an automated process, in an alternative embodiment it may still be desirable to seek user approval before performing certain steps such as uninstalling software as occurs in step 520 or launching the software as occurs from steps 565 through 580. This can be accomplished, for example, by generating a display asking the user to approve the uninstallation at any point before performing step 520. However, generating such display is preferably avoided in other embodiments so as to maintain the fully automated nature of the present process.

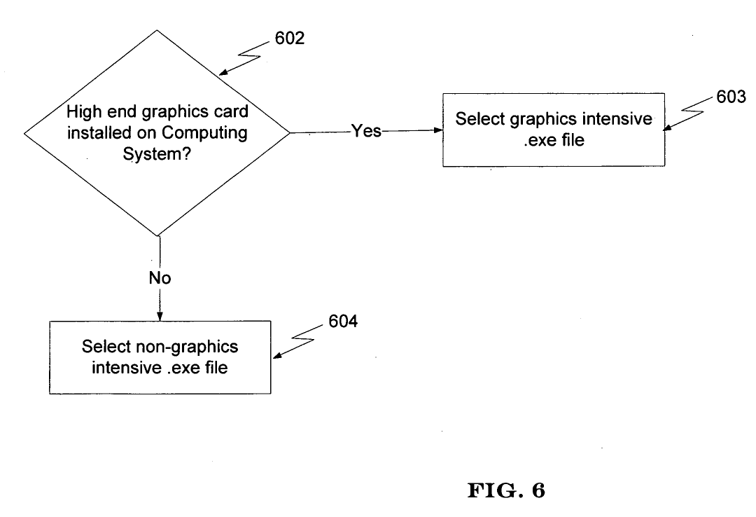

Referring now to FIG. 6, a flow chart representation of one example of steps 535 and 540 can be seen. In step 602, as explained elsewhere herein the computing system is investigated to determine whether a high end graphics card is installed. For example, a command can be issued to Microsoft Windows to directly obtain this information or, alternatively, the GetDeviceCaps command function can be used to obtain screen resolution information from which the installed graphics card capabilities can be determined indirectly. If the answer is yes that a high end graphics card is installed, then in step 603, a version of the software to be installed and/or launched that is graphics intensive is selected. Alternatively, if the answer is no, then in step 604, a version of the software to be installed and/or launched that is not graphics intensive is selected.

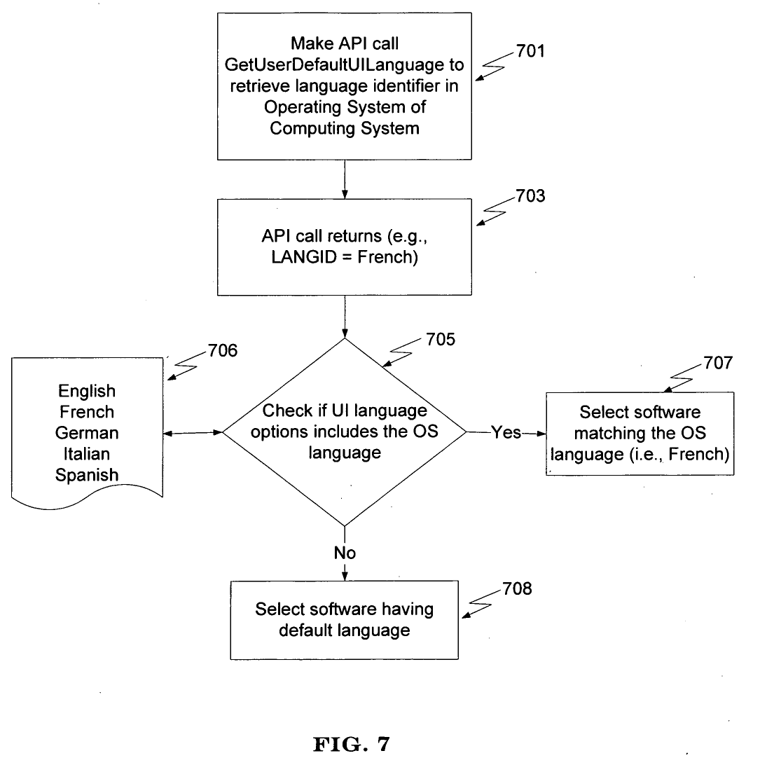

Referring now to FIG. 7, a flow chart representation of another example of steps 535 and 540 can be seen. In step 701, the computing system is investigated to determine what language identifier is specified in the operating system of the computing system. In this particular example using the Windows operating system, an Application Programming Interface (“API”) call is made using a “GetUserDefaultUILanguage” command. In step 703, the API call returns a value indicative of a specified language. In step 706, this value is compared against the available options for the software to be installed and/or launched on the computing system. If there is a match, in step 707 the software matching the specified language is selected for installation and/or launching. Alternatively, if there is not a match, in step 708 the software selected for installation and/or launching is the one having a default language such as English.

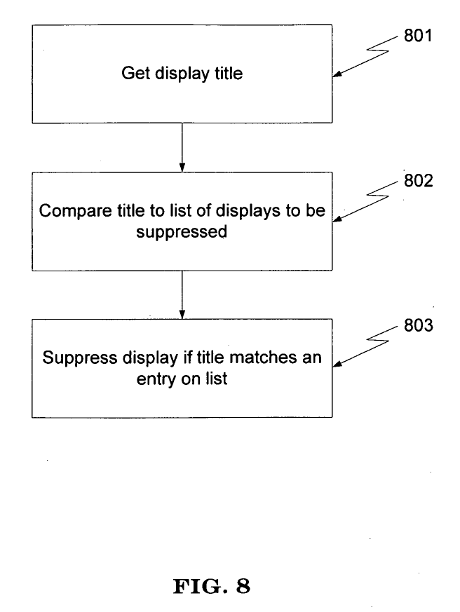

Referring now to FIG. 8, a flow chart representation of an example of steps 550 and 555, as well as steps 570 and 575, can be seen. In step 501, the display title is obtained, as explained elsewhere herein. In step 802 the obtained title is compared against a list of displays to be suppressed, as explained elsewhere herein. Then, in step 803, the display is suppressed if the title matches an entry on the list, as explained elsewhere herein.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive. It will be recognized that the terms “comprising,” “including,” and “having,” as used herein, are specifically intended to be read as open-ended terms of art.

What is claimed is:

1. A computer readable medium containing program code for automatically installing software on a computing system comprising the steps of:
initiating an AutoRun sequence of the computing system;
investigating the computing system to identify any previously installed software known to conflict with the software to be installed on the computing system;
uninstalling any identified previously installed software known to conflict with the software to be installed on the computing system;
investigating the computing system to identify any currently running software known to conflict with the software to be installed on the computing system;
terminating any identified currently running software known to conflict with the software to be installed on the personal computer;
investigating the computing system to identify configuration details of the computing system;
selecting a version of the software to be installed on the computing system based on the identified configuration details of the computing system;
initiating installation of the selected version of the software to be installed on the computing system;
identifying any displays on the computing system previously determined to not require user action;
suppressing any identified displays on the computing system previously determined to not require user action; and,
completing installation of the selected version of the software to be installed on the computing system.

2. The computer readable medium containing program code for automatically installing software on a computing system of claim 1 where the program code further comprises the steps of:
initiating launch of the installed selected version of the software on the computing system;
identifying any displays on the computing system previously determined to not require user action;
eliminating any identified displays on the computing system previously determined to not require user action; and,
completing launch of the installed selected version of the software on the computing system.

3. The computer readable medium containing program code for automatically installing software on a computing system of claim 1 where the program code further comprises the step of seeking user approval before the step of uninstalling any identified previously installed software known to conflict with the software to be installed on the computing system.

4. The computer readable medium containing program code for automatically installing software on a computing system of claim 1 wherein the identified configuration details include details about an operating system of the computing system.

5. The computer readable medium containing program code for automatically installing software on a computing system of claim 1 wherein the identified configuration details include details about hardware configuration of the computing system.

6. The computer readable medium containing program code for automatically installing software on a computing system of claim 1 wherein the identified configuration details include details about software configuration of the computing system.

7. The computer readable medium containing program code for automatically installing software on a computing system of claim 1 wherein the selected version of software is an executable file.

8. The computer readable medium containing program code for automatically installing software on a computing system of claim 1 wherein the selected version of software is a group of software modules.

9. The computer readable medium containing program code for automatically installing software on a computing system of claim 1 wherein previously installed software known to conflict with the software to be installed on the computing system is based on a list of conflict software.

10. The computer readable medium containing program code for automatically installing software on a computing system of claim 1 wherein identifying displays on the computing system previously determined to not require user action uses a predefined list of display titles.

11. The computer readable medium containing program code for automatically installing software on a computing system of claim 1 wherein displays include dialog boxes and pop-up windows.

12. A computer readable medium containing program code for automatically launching software on a computing system without requiring user action comprising the steps of:
initiating an Autorun sequence of the computing system;
investigating the computing system to identify any currently running software known to conflict with the software to be launched on the computing system;
terminating any identified currently running software known to conflict with the software to be launched on the computing system;
investigating the computing system to identify configuration details of the computing system;
selecting a version of the software to be launched on the computing system based on the identified configuration details of the computing system;
initiating launch of the selected version of the software to be launched on the computing system;
identifying any displays on the computing system previously determined to not require user action;
eliminating any identified displays on the computing system previously determined to not require user action; and,
completing launch of the selected version of the software to be launched on the computing system.

13. A computer readable medium containing program code for automatically launching software on a computing system without requiring user action comprising the steps of:
initiating an Autorun sequence of the computing system;
investigating the computing system to identify any currently running software known to conflict with the software to be launched on the computing system;
terminating any identified currently running software known to conflict with the software to be launched on the computing system;
initiating launch of the software to be launched on the computing system;
identifying any displays on the computing system previously determined to not require user action;
eliminating any identified displays on the computing system previously determined to not require user action; and,
completing launch of the software to be launched on the computing system.
